(19) United States
(12) Patent Application Publication
(10) Pub. No.: US 2008/0050590 A1
(43) Pub. Date: Feb. 28, 2008

(54) Wire and Cable Insulation

(76) Inventors: Giles Rodway, Calne (GB); Stuart Steadman, Swindon (GB)

Correspondence Address: BARLEY SNYDER, LLC, 1000 WESTLAKES DRIVE, SUITE 275, BERWYN, PA, 19312, US

(21) Appl. No.: 11/782,230

(22) Filed: Jul. 24, 2007

(30) Foreign Application Priority Data
Aug. 22, 2006 (GB) 0616631.8

(51) Int. Cl. H01B 3/02; B32B 27/00

(52) U.S. Cl. 428/394; 428/364

(57) ABSTRACT

A wire and cable insulation includes a wire or a cable having an inner layer and an outer layer of insulation. The outer layer includes an uncoated magnesium hydroxide. The inner layer and the outer layer each have less than 1 percentage by weight of halogen.

### CROSS-REFERENCE TO RELATED APPLICATIONS

This application claims the benefit of the filing date under 35 U.S.C. § 119(a)-(d) of Great Britain Patent Application No. 0616631.8, filed Aug. 22, 2006.

### FIELD OF THE INVENTION

The invention relates to wire and cable insulation wherein the insulation comprises an inner layer and an outer layer having less than 1 percentage by weight of halogen.

### BACKGROUND

In many industries it is essential that wire or cable insulation fulfill durability requirements in order to be certified for use in specific situations. For instance, in the automotive industry, automotive wiring for use in wiring harnesses is required to be stable upon exposure to high temperatures for considerable periods of time. For example, some automotive wiring insulation must fulfill the “class 3” requirement, which requires survival intact for 3000 hours at 125° C. In addition, insulation for automotive wiring is required to be resistant to exposure to aggressive fluids such as engine oil and windscreen washer fluid commonly found in automotive environments. Further, wire and cable insulations for use in the automotive industry must be suitable for contact with an assortment of adhesive and non-adhesive tapes, tubing, connectors, seals and alternative cable jacket materials if the insulation is to be efficiently used in this industry, because it is not economically viable to produce wiring harnesses which avoid the use of these components.

There are currently two principle commercial insulation systems that fulfill the “class 3” requirement. Both of these commercial insulation systems are single wall insulations incorporating polypropylene or cross-linked polyethylene polymers and are either low-halogen or zero-halogen. The low halogen insulation typically contains about 12 wt % bromine, as a flame retarding component, combined with diantimony trioxide. However, although this combination is very effective at vapor phase flame retarding, concerns exist over possible effects on the environment of the combustion of certain halogenated compounds. It is therefore an objective in the wire and cable industry to produce high performance insulation without the inclusion of halogen-containing compounds.

The zero-halogen insulation typically contains high levels of hydrated mineral fillers such as 55 wt % to 60 wt % of magnesium hydroxide or aluminum hydroxide. An example of a zero-halogen single wall polypropylene insulation may be found in WO 02/073631, which describes an insulation comprising at least 30 wt % polypropylene homopolymer and/or copolymer, at least 2 wt % zinc sulphide and/or at least 5 wt % zinc oxide of the whole composition. The hydrated mineral fillers confer flame retardancy through dilution of the combustible polymer and through loss of the water of hydration during heating or combustion, which results in high heat absorption. Accordingly, known zero-halogen insulations overcome the environmental concerns associated with the use of halogenated insulating materials.

However, the exclusion of halogens from the insulating materials has produced insulation with inferior mechanical properties, in particular in terms of insulation abrasion resistance and the capacity of the insulation to be stretched before it snaps or breaks. Zero-halogen compounds have also historically suffered from poorer chemical and environmental resistance than halogenated products, and have had difficulty in simultaneously meeting industry standards in terms of electrical and flammability requirements, because it is easier to meet the standard electrical requirements by reducing the levels of fillers such as magnesium hydroxide or aluminum hydroxide, but more difficult to conform to the flammability standards if this is done.

### BRIEF SUMMARY

It is therefore an object of the invention to provide a zero-halogen wire or cable insulation without the drawbacks described above. In particular, it is desirable to develop a zero-halogen wire or cable insulation that can be used by the automotive industry, in particular in automotive wiring harnesses.

This and other objects are achieved by a wire and cable insulation comprising a wire or a cable having an inner layer and an outer layer of insulation. The outer layer includes an uncoated magnesium hydroxide. The inner layer and the outer layer each have less than 1 percentage by weight of halogen.

### BRIEF DESCRIPTION OF THE DRAWINGS

FIG. 1 is a schematic cross-sectional view of a wire coated with an insulation according to various embodiments of the invention.

### DETAILED DESCRIPTION OF THE EMBODIMENT(S)

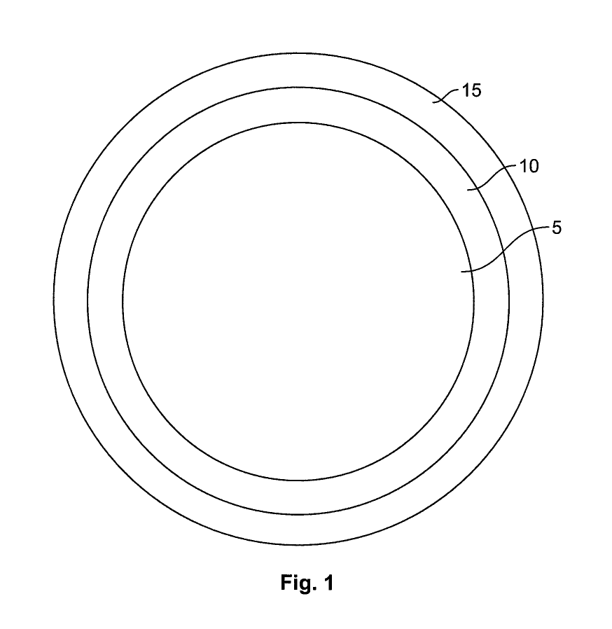

FIG. 1 shows a wire 5 provided with an inner layer 10 and an outer layer 15 of insulation. Although FIG. 1 shows a single wire 5, it will be appreciated by those skilled in the art that the wire 5 may alternatively consist of a single cable, multiple wires or multiple cables. Additionally, although FIG. 1 shows the insulation as comprising the inner layer 10 and the outer layer 15, it will be appreciated by those skilled in the art that one or more intermediate layers may be formed between the inner and outer layer 10, 15.

As used herein, the term “zero-halogen” intends to include any insulation with less than 1 wt % halogen. In particular, it is preferred that less than 0.5 wt % halogen be present, more preferably 0.1 wt %, and most preferably only trace impurities. In typical embodiments, no halogen-containing compound will be added to a zero-halogen insulation and accordingly any halogen which is present typically arises, purely as a result of impurities in the materials used to form the insulation. As used herein, the term ‘uncoated’ should be regarded as relating to magnesium hydroxide powders which have not been treated to coat an external surface of the powder with a secondary chemical. In addition, values given in terms of percentage by weight (wt %) refer to the weight percentage of that component within a given layer unless specifically states as being the weight percentage of the insulation as a whole.

In some embodiments, the inner layer 10 of the insulation comprises inorganic filler in the range of about 0-20 wt % and/or the outer layer 15 comprises about 55 wt % of uncoated magnesium hydroxide or greater. This composition provides an insulation in which the outer layer 15 is strongly flame retarded and the inner layer 10 is either non-retardant or lightly retarded. This allows the inner layer 10 to meet electrical performance requirements and the outer layer 15 to meet the flammability requirements of the insulation.

In some embodiments the inner layer 10 and/or the outer layer 15 comprises a polypropylene copolymer. It is often desirable for both the inner and outer layers 10, 15 to comprise polypropylene. Where present, the polypropylene may be a polypropylene homopolymer or copolymer; however, typically the polypropylene will be a polypropylene copolymer. Copolymers are preferred as they offer better flexibility and resistance to elongation. In addition, copolymers typically exhibit better low temperature properties and resistance to cracking than homopolymers. Where the inner layer 10 comprises polypropylene, it will preferably be present in the range of about 20-50 wt %, more preferably in the range of about 25-35 wt %.

The inner layer 10 may preferably additionally comprise one or more components selected from about 30-60 wt % high density polyethylene, 5-15 wt % thermoplastic elastomer, 1-6 wt % antioxidant package and up to about 5 wt % minor ingredients. For example, the inner layer 10 of the insulation may comprise one or more components selected from about 30 wt % polypropylene copolymer, 52 wt % high density polyethylene, 9 wt % thermoplastic elastomer, 4 wt % antioxidant package and up to about 5 wt % minor ingredients. In particularly advantageous embodiments, the inner layer 10 may comprise from about 20-50 wt % polypropylene, 30-60 wt % high density polyethylene, 5-15 wt % thermoplastic elastomer, 1-6 wt % antioxidant package and up to about 5 wt % minor ingredients.

The elastomer improves the flexibility of the insulation thereby reducing the damage resulting from bending the wire 5 during use. The elastomer may be, for example, an ethylene-propylene-diene-monomer (EPDM) based elastomer. It will be appreciated by those skilled in the art, however, that may different types of elastomers may be used. The minor ingredients include, for instance, copper stabilizers such as zinc sulphide, cross-linking promoters, pigments and processing aids. The copper stabilizers offer increased compatibility with engine harness components and improve the protection available against aggressive fluids used in the automotive environment.

The inner layer 10 may be of thickness typical to that of known wire or cable insulations, and will depend upon the gauge of the wire 5 to be protected. For example, the inner layer 10 may have a thickness in the range of about 0.1 mm-0.25 mm. When the wire 5 is a 0.75 mm² gauge wire, the inner layer 10 will preferably have a thickness of about 0.15 mm. It will be appreciated by those skilled in the art, however, that this thickness would also be appropriate for the protection of wires and cables of other gauges.

In some embodiments the flame-retardant qualities of the outer layer 15 are achieved through the inclusion within the outer layer 15 of two or more filler compatible elastomers, for example, elastomers capable of wetting filler particles, thereby facilitating mixing between the filler and the elastomer. The outer layer 15 may comprise a primary elastomer and a secondary elastomer, which will often be present in a weight ratio in the range of about 4:1 to about 2:1, and preferably about 3:1, depending upon the gauge of the wire 5. Typically, the first elastomer will be the elastomer present in the greatest proportion of the insulation. The combination of the elastomers and the filler give the outer layer 15 good mechanical performance, abrasion resistance and low temperature behavior.

The primary elastomer and the secondary elastomer may be selected from ethylene propylene elastomer, modified polyethylene resin, polypropylene copolymer and an ethylene-propylene alloy. In some embodiments, the primary elastomer may be an ethylene propylene elastomer and the secondary elastomer may be a modified polyethylene resin. The ethylene propylene elastomer imparts improved cold wind performance and the polyethylene resin improves the abrasion properties of the layer and imparts mechanical strength. In alternative embodiments, the primary elastomer may be a polypropylene copolymer and the secondary elastomer may be an ethylene-propylene alloy.

The outer layer 15 may comprise about 0-50 wt % polypropylene, preferably about 0-20 wt % polypropylene, and more preferably about 5-16 wt % polypropylene, in addition to the uncoated magnesium hydroxide flame retardant. The outer layer 15 may additionally comprise one or more components selected from about 6-12 wt % primary elastomer, 3-8 wt % secondary elastomer, 55-70 wt % uncoated magnesium hydroxide, 1-6 wt % antioxidant package and up to about 6 wt % minor ingredients. For example, the outer layer 15 may comprise one or more components selected from about 16 wt % polypropylene copolymer, 9 wt % primary elastomer, 5 wt % secondary elastomer, 4 wt % antioxidant package and up to about 6 wt % minor ingredients. The minor ingredients incorporated into the outer layer 15 will be similar to those appropriate for inclusion in the inner layer 10 and described above.

In particularly advantageous embodiments, the outer layer 15 may comprise about 20-50 wt % polypropylene, 6-12 wt % primary elastomer, 3-8 wt % secondary elastomer, 55-70 wt % uncoated magnesium hydroxide, 1-6 wt % antioxidant package and up to about 6 wt % minor ingredients. Alternatively, the outer layer 15 may comprise (in addition to polypropylene) one or more components selected from about 15-30 wt % ethylene-propylene alloy, 55-70 wt % uncoated magnesium hydroxide, 1-6 wt % antioxidant package and up to about 6 wt % minor ingredients. For example, the outer layer 15 may comprise one or more components selected from about 5 wt % polypropylene copolymer, 24 wt % ethylene-propylene alloy, 61 wt % uncoated magnesium hydroxide, 4 wt % antioxidant package and up to about 6 wt % minor ingredients. It is often desirable that the outer layer 15 comprise from about 0-10 wt % polypropylene copolymer, 15-30 wt % ethylene-propylene alloy, 55-70 wt % uncoated magnesium hydroxide, 1-6 wt % antioxidant package and up to about 6 wt % minor ingredients.

It is preferred that the uncoated magnesium hydroxide whether present in the outer layer 15 or optionally present in the inner layer 10 has a particle size (d90) in the range of about 3 μm-40 μm, preferably in the range of about 10 μm-20 μm. The most preferred particle size is about 15 μm, a particularly coarse particle size for an inorganic flame retardant that would typically be expected to result in a poor quality insulation, at least in terms of abrasion resistance and stability at high temperature. Known magnesium hydroxide containing insulations typically include magnesium hydroxide of particle size less than about 3 μm. However, it has surprisingly been found that the incorporation of relatively coarse particulate matter into the inventive insulations offers an insulation with exceptional properties.

The outer layer 15 may be of thickness typical to that of known wire or cable insulations, and will depend upon the gauge of the wire 5 to be protected. For example, the outer layer 15 may have a thickness in the range of about 0.1 mm-0.25 mm. When the wire 5 is a 0.75 mm gauge wire, the outer layer 15 will preferably have a thickness of about 0.15 mm. It will be appreciated by those skilled in the art, however, that this thickness would also be appropriate for the protection of wires and cables of other gauges.

The total combined thickness of the inner and outer layers 10, 25 of the insulation may fall within the range of about 0.1 mm-0.5 mm, preferably in the range of about 0.2-0.35 mm, depending upon the gauge of the wire 5. The inner and outer layers 10, 15 have a thickness in the ratio of about 2.5:1 to 1:2.5, preferably in the range of about 2:1 to 1:2 by thickness of the layer.

In order to form the wire 5 with the insulation, the inner and outer layers 10, 15 may be co-extruded directly into the wire 5. Alternatively, the inner layer 10, the outer layer 15 and any additional intervening layers may be sequential extruded onto the wire 5. So that a stable dual or multi-layer insulation is formed, it is preferred that the layers of the insulation form a strong bond during manufacture of the insulation. This bond may be chemical or mechanical or a combination of chemical and mechanical interactions. For example, the bond could arise during co-extrusion through a low level of mechanical mixing or interdiffusion at the interface between the layers. Alternatively, the bond could arise through covalent or intermolecular bonding between the layers. The formation of a strong bond between the layers is believed to improve the elongation and abrasion resistance of the insulation as the outer layer 15 adopts many of the beneficial mechanical characteristics of the tougher inner layer 10.

In a first example of an embodiment of the invention, the inner and outer layers 10, 15 of the insulation are co-extruded onto the wire 5. The wire 5 is a 0.75 mm² gauge wire. The inner and outer layers 10, 15 are each present in a thickness of about 0.15 mm. The inner layer 10 comprises about 30 wt % polypropylene copolymer, 52 wt % high density polyethylene, 9 wt % thermoplastic elastomer, 4 wt % antioxidant package and 5 wt % of the usual minor ingredients including cross-linking promoters, copper stabilizers, pigments and processing aids. The outer layer 15 comprises about 16 wt % polypropylene copolymer, 9 wt % primary elastomer, 5 wt % secondary elastomer, 60 wt % uncoated magnesium hydroxide of mean particle size 15 μm, 4 wt % antioxidant package and 6 wt % of the usual minor ingredients including cross-linking promoters, copper stabilizers, pigments and processing aids. The wire 5 according to the first embodiment of the invention is suitable for use as automotive wiring and fulfills the “class 3” requirement, which requires survival intact for 3000 hours at 125° C.

In a second example of an embodiment of the invention, the inner and outer layers 10, of the insulation are sequentially extruded onto the wire 5. The wire 5 is a 0.75 mm² gauge wire. The inner and outer layers 10, 15 are each present in a thickness of about 0.20 mm. The inner layer 10 comprises about 30 wt % polypropylene copolymer, 52 wt % high density polyethylene, 9 wt % thermoplastic elastomer, 4 wt % antioxidant package and 5 wt % of the usual minor ingredients including cross-linking promoters, copper stabilizers, pigments and processing aids. The outer layer 15 comprises about 5 wt % polypropylene copolymer, 24 wt % of a catalloy with a MFI of approximately 0.8 (an ethylene-propylene alloy), 61 wt % uncoated magnesium hydroxide of mean particle size 15 μm, 4 wt % antioxidant package and 6 wt % of the usual minor ingredients including cross-linking promoters, copper stabilizers, pigments and processing aids. The wire 5 according to the second embodiment of the invention is suitable for use as automotive wiring and fulfills the “class 3” requirement, which requires survival intact for 3000 hours at 125° C.

The wire 5 according to the first and second examples of embodiments of the invention is inexpensive to produce and can tolerate exposure to high temperatures for long periods of time and exposure to aggressive fluids such as those fluids found within an engine bay, for example, engine oil or windscreen washer fluid. Further, the wires 5 can be used in combination with an assortment of adhesive and non-adhesive tapes, tubing, connectors, seals and alternative cable jacket materials. In particular, the presence of the uncoated magnesium hydroxide in the outer layer 15 provides a layer which is highly flame retardant, but inexpensive to produce as it is not necessary to purchase or prepare expensive coated magnesium hydroxide.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A wire and cable insulation, comprising:
a wire or a cable having an inner layer and an outer layer of insulation, the outer layer including uncoated magnesium hydroxide.

2. The wire and cable insulation of claim 1, wherein the inner layer and the outer layer each have less than 1 percentage by weight of halogen.

3. The wire and cable insulation of claim 1, wherein the inner layer includes an inorganic filler, the inner layer having about 0-20 percentage by weight of the inorganic filler.

4. The wire and cable insulation of claim 1, wherein the outer layer has about 55 percentage by weight of the uncoated magnesium hydroxide or greater.

5. The wire and cable insulation of claim 1, wherein the inner layer and the outer layer each include a polypropylene copolymer.

6. The wire and cable insulation of claim 5, wherein the inner layer has about 20-50 percentage by weight of the polypropylene copolymer.

7. The wire and cable insulation of claim 6, wherein the inner layer has about 25-35 percentage by weight of the polypropylene copolymer.

8. The wire and cable insulation of claim 5, wherein the inner layer includes at least one of about 30-60 percentage by weight of high density polyethylene, 5-15 percentage by weight of thermoplastic elastomer, 1-6 percentage by weight of antioxidant package or up to about 5 percentage by weight of minor ingredients.

9. The wire and cable insulation of claim 5, wherein the outer layer comprises has about 0-50 percentage by weight of the polypropylene copolymer.

10. The wire and cable insulation of claim 9, wherein the outer layer comprises has about 0-20 percentage by weight of the polypropylene copolymer.

11. The wire and cable insulation of claim 10, wherein the outer layer comprises has about 5-16 percentage by weight of the polypropylene copolymer.

12. The wire and cable insulation of claim 1, wherein the inner layer has a thickness of about 0.1 mm-0.25 mm and the outer layer has a thickness of about 0.1 mm-0.25 mm.

13. The wire and cable insulation of claim 1, wherein the outer layer includes a primary elastomer and a secondary elastomer, the primary and secondary elastomers being filler compatible.

14. The wire and cable insulation of claim 13, wherein the primary and secondary elastomers have a weight ratio of about 4:1 to about 2:1.

15. The wire and cable insulation of claim 13, wherein the primary elastomer is a ethylene propylene elastomer, modified polyethylene resin, polypropylene copolymer or an alloy of ethylene and propylene.

16. The wire and cable insulation of claim 15, wherein the secondary elastomer is a ethylene propylene elastomer, modified polyethylene resin, polypropylene copolymer or an alloy of ethylene and propylene.

17. The wire and cable insulation of claim 13, wherein the outer layer includes at least one of about 6-12 percentage by weight primary elastomer, 3-8 percentage by weight secondary elastomer, 55-70 percentage by weight uncoated magnesium hydroxide, 1-6 percentage by weight antioxidant package or up to about 6 percentage by weight minor ingredients.

18. The wire and cable insulation of claim 1, wherein the uncoated magnesium hydroxide has a particle size in the range of about 3 μm-40 μm.

19. The wire and cable insulation of claim 18, wherein the uncoated magnesium hydroxide has a particle size in the range of about 10 μm-20 μm.

20. The wire and cable insulation of claim 1, wherein the thickness ratio of outer layer to inner layer is about 2:1 to about 1:2.
